(19) United States
(12) Patent Application Publication
(10) Pub. No.: US 2009/0149160 A1
(43) Pub. Date: Jun. 11, 2009

(54) METHOD AND SYSTEM FOR DIRECTIVE TRANSMITTING CONTENT PROCESSED AT TELECOM TRANSMISSION TERMINALS AND FOR DISTRIBUTED CONTENT TRANSMISSION CONNECTING TO NETWORKS

(76) Inventor: Edward J. Sang, Shanghai (CN)

Correspondence Address: KENYON & KENYON LLP, ONE BROADWAY, NEW YORK, NY, 10004, US

(21) Appl. No.: 12/097,145

(22) PCT Filed: Dec. 11, 2006
(86) PCT No.: PCT/CN2006/003368

§ 371 Date: Sep. 24, 2008

(30) Foreign Application Priority Data
Dec. 12, 2005 (CN) 200510111396.8

(51) Int. Cl. H04W 4/00

(52) U.S. Cl. 455/414.1; 455/466

(57) ABSTRACT

This invention relates to network communication technologies and the associated system and describes a method and a system for directive transmitting contents processed at telecom transmission terminals and for distributed content transmission connecting to networks. The presented method of the invention configures system structure of a network, and co-operative functions of an associated content-name-to-address connection system or similar systems, and the configuration and functions of telecom transmission terminals, in which each communication protocol or service code responds in different sequence. The method any system of this invention does not require users to memorize and to input any Telecom Service Codes at telecom transmission terminals, effectively initiating and executing functions of key word(s) search or SMS information response or WAP domain name connection or general connection with Content Name(s) by pressing hardware key/button, at the same time, achieving the distributed content transmission connecting to network for telecom terminals.

### FIELD OF THE INVENTION

This invention relates to network communication technologies and the associated system configurations of software and hardware components; in particular, it closely relates to wireless data communication technologies and network communication technologies. This invention describes a method and a system for directive content transmission of any word(s), phrase(s), or symbol(s) of any languages processed at telecom transmission terminals and for distributed content transmission connecting to networks, by configuring relevant telecom transmission protocols or a group of telecom transmission access codes in telecom transmission terminals and executing related process.

### BACKGROUND OF THE INVENTION

For current telecom terminals, such as mobile phones, network computers, PHS, users need to dial telecom codes, or input URI or IP address on the terminals to initiate and execute transmitting the content to the receiving systems. For mobile terminals, users who are sending SMS need to dial/input target mobile phone's numbers or SMS service codes provided by telecom mobile carriers. When surfing wireless Internet via mobile phone, they need to input the URI or IP address of target WAP sites using input devise of terminals. SMS Service Codes, usually provided by telecom mobile carriers, are used by Service Providers (SPs) for value added services used by mobile terminal users. The SMS Service Codes provided by telecom carrier currently is a four-digit number, and SPs can provide Sub Service Codes with random digits by adding additional random digits and at any random length but with maximum up to 15 digits along with original 4 digits, and random digital number. When deploying Namelink technology or other similar technologies, mobile terminal users input Content Name(s) and dial to SMS Service Codes, provided by telecom carrier, for information connection or for search; when surfing wireless Internet, mobile terminal users can access target WAP or Web sites by inputting and transmitting Content Names associated with URI or IP address of corresponding sites. Currently, mobile terminal users need to know and memorize Service Codes, or the URI or IP addresses of target WAP or Web sites, and also input them on terminals when accessing. It is difficult to memorize and cumbersome for inputting when these SMS Service Codes or URI or IP addresses are used, resulting in poor user experiences. When a single popular Service Code is used, all mobile terminal users' access to a single Service Code Getaway can cause traffic jam and create problems for the service system, since it is not an optimized structure of distributed accessing system.

### SUMMARY OF THE INVENTION

The purpose of the invention is to develop a method for directive content transmission at telecom terminal, and a telecom terminal system based on the method, working with an associated content-name-to-code connection system or other similar systems. The method and system no longer require users to know or memorize Service Codes or transmission procedures or the URI/IP addresses of target WAP sites, and to add new features and functions of telecom terminals, as well as for telecom terminals to access wireless Internet or Internet networks with distributed structure.

For the purpose of the invention above, this method for directive transmitting content processed at telecom transmission terminals and for distributed content transmission connecting to networks, comprises:
a) Set up a content-name-to-address connection system, in which a group of Telecom Codes is selected, each of Telecom Codes is characterized with the first part as a directly dialed Head Code and the second part as a Sub Code that contains extra digits of Arabic numbers following the original Head Code. Each Sub Code within the selected group is non-ambiguous and unique, but can be the same set of numbers as the ones from other groups of Sub Codes or be connected to them. The selected group of Telecom Codes is configured in a database. Any digits of Telecom Codes in the selected group or any other groups are any characters permitted by telecom network systems.
b) In present content-name-to-address connection system, Collect Connecting Information Sources or URIs or IP Addresses and group them, then list in a Directory.
c) Define a unique format or form of any selected word(s), phrase(s), or symbol(s) from any languages, or of any multimedia expressions, or of any combination of the above, as a Content Name. Each of such unique Content Names can be located in any place within the transmitted data. All the defined Content Names are configured in a database.
d) Assign one specific or a specific group of Content Names to one specific or a specific group of Telecom Codes, and to one specific Connecting Content or URI or IP Address, between them the connection relations and the rules of directing are characterized as valid and executable, but are not necessarily on a one-to-one basis. Each of the connection relations and of the rules of directing is configured in the database.
e) Design a set of logic structures and computing programs to manage the Telecom Codes, Content Names, and connecting/directing functions, to receive and analyze the content transmitted, to detect the existence of any specific Content Name, and to redirect the transmitted content to the connected Telecom Codes; or to match particular URI or IP address with corresponding Content Name(s), and to redirect the connection that results in to display the content from a particular URI or IP address on Terminals.
f) The present system receives content or Content Name during transmitting telecom data, and connects words, phrases, or symbols of any languages to telecommunication codes, or to URI or IP Address
g) Design a telecom transmission terminal which processes and completes directive contents transmission, and connects to networks in distributed transmission mode.
h) Set relevant telecom transmission protocols or a group of telecom transmission codes associated with content-name-to-address connection system or other similar system in telecom transmission terminals, and each protocol or code responds in different sequence, different transmission contents are sent to different gateways from different telecom transmission terminals, as a result, telecom transmission terminals connect to network in distributed transmission mode.

In this method for directive transmitting content processed at telecom transmission terminals and for distributed content transmission connecting to networks, Telecom Codes are Short Message Service (SMS) Short Codes provided by Mobile Telecom Carriers, or Sub Short Codes, which are extensions of SMS Short Codes along with the SMS Short Codes as the Head Codes and followed by any additional digits of any Arabic numbers up to a maximum of 15 digits.

In this method for directive transmitting content processed at telecom transmission terminals and for distributed content transmission connecting to networks, URI or IP Address is URI or IP Address of multimedia expression or stream media or are URIs or IP Addresses of multimedia expression or stream media.

In this method for directive transmitting content processed at telecom transmission terminals and for distributed content transmission connecting to networks, the contents of transmitted telecom data are SMS contents in wireless communications or instant message (IM) contents in instant communications.

In this method for directive transmitting content processed at telecom transmission terminals and for distributed content transmission connecting to networks, assignments of Content Names connecting to Telecom Codes are in three types: a specific Content Name connecting to a specific Telecom Code, a specific Content Name connecting to multiple Telecom Codes, and multiple Content Names connecting to a specific Telecom Code.

In the system based on this method for directive transmitting content processed at telecom transmission terminals and for distributed content transmission connecting to networks, includes the associated configurations of content-name-to-address connection system or other similar systems, comprises hardware system and software system, so does the telecom transmission terminal. the content-name-to-address connection system can accomplish the functions of directive transmitting contents and of distributed content transmission connecting to networks, The hardware portion of this system comprises a Processor, a Memory, a Display Device, an Input Device, and a Communication Interface, and the Processor connects with other hardware portions; the software portion of the system comprises an Operating System, Client Data Management Modules including Management Interface, a Database Software, a collection of Telecom Codes or any other codes permitted by telecom networks and configured in the Database Software, a group of defined Content Names configured in the Database Software, the Connection Relations and the Rules of Directing configured in the Database Software, Analysis and Directing Function Modules, and Communication Interfaces; the hardware portion of telecom transmission terminal comprises a Processor, a Memory, a Display Device, an Input Device, and a Communication Interface, and the Processor connects with other hardware portions, the software portion telecom transmission terminal comprises operating system, protocol/code setting module, editing module, directive transmitting module, telecom communication interface module.

In the system for directive transmitting content processed at telecom transmission terminals and for distributed content transmission connecting to networks, the telecom content transmission is initiated to process within the telecom transmission terminal when a hardware key/button is pressed.

In the system for directive transmitting content processed at telecom transmission terminals and for distributed content transmission connecting to networks, the telecom content transmission initiated for processing within the telecom transmission terminal is the action of key word(s) searching or connecting WAP/SMS site(s) by the Content Name when a hardware key/button is pressed.

In the system for directive transmitting content processed at telecom transmission terminals and for distributed content transmission connecting to networks, the hardware part of telecom transmission terminal includes a Processor, a Memory, a Display Device, an Input Device, and a Communication Interface, which are computing hardware components or hardware components of mobile terminals as well as parts of prior arts; The software portion of telecom transmission terminal comprises: computing operation systems with compatible software functional modules or operating systems for mobile terminals of prior arts with compatible software function modules.

This method and system for directive transmitting contents processed at telecom transmission terminals and for distributed content transmission connecting to networks, mainly relates to system structure of a network, and co-operative functions of an associated content-name-to-address connection system or similar systems, particularly relates to configuration and functions of telecom transmission terminals. This method and system improves and adds features and functions of telecom transmission terminal. As such, this method and system have solved the problems associated with long codes with many digits of numbers, which are very difficult to remember and cumbersome and inefficient to key in, in addition, it is an optimized structure as a distributed accessing system for telecom transmission terminals, in which network traffic balance and best utilization of network resources is achieved, when the number of users rises to high levels. This method and system also leads to the development of four new applications:

1. Linkage to SMS information or WAP site is initiated and Executed when hardware key/button of telecom transmission terminal is pressed.

The method and system of this invention can initiate and execute the linkage of SMS information or WAP sites when hardware key/button of telecom transmission terminal is pressed, achieving functional effect of domain names. It no longer require terminal users to memorize and input any telecom Service Codes, only to input Content Name, such as “hospital”, in SMS, then to press hardware key/button on the terminal to send, users can receive the desired information from replied SMS or the linkage to an associated WAP site. As in the example mentioned above, this is very convenient and simple for mobile phone users to input “hospital” in SMS, and then press hardware key/button to send, users then receive relevant information in SMS linked to this Content Name or directed to the corresponding WAP site. WAP site linkage can lead to many contents, such as news summary, financial service (bank and securities), weather, travel, hotel, restaurant, insurance, health, fashion, entertainment, etc, the key point of this invented method and system is to provide a direct linkage from Content Name to the associated information supplied in SMS or WAP format and to provide the desired information for users.

2. Key word search is initiated and executed when hardware key/button of telecom transmission terminal is pressed.

The method and system of this invention can initiate and execute key word search in SMS when hardware key/button of telecom transmission terminal is pressed, effectively transforming SMS editing interface into a search key word input box. It no longer require terminal users to memorize and input any telecom Service Codes, only to input key word, such as “hospital”, in SMS, then to press hardware key/button on the terminal to send, users can receive the search result in SMS or WAP format. This search function can lead to many contents as search results, such as news summary, financial service (bank and securities), weather, travel, hotel, restaurant, insurance, health, fashion, entertainment, etc.

3. A general function is initiated and executed when hardware key/button of telecom transmission terminal is pressed.

The method and system of this invention can initiate and execute transmission of a unique format or form of a Content Name within the transmitting content when hardware key/button of telecom transmission terminal is pressed, such a Content Name can be any word(s), phrase(s), or symbol(s) of any language, or any combinations of the above, achieving a general functional effect of transmitting. During the process, it does not require terminal users to memorize and to input any telecom Service Codes.

4. Distributed connecting to networks by telecom transmission terminals.

Because it does not require users to memorize or to use a single telecom Service Code, each of different codes can be stored in different terminals, which serves as the foundation for distributed connecting to network by telecom transmission terminals. Transmitting contents from different terminals can be directed to different gateways by different Service Codes, resulting in a system structure of distributed connecting to networks. For example, users transmit content to a single Service Code, such as 93939, all transmitted contents are directed to a single gateway, which may cause communication traffic congestion, when there are multiple gateways in service, transmission becomes more efficient, and traffic flow are balanced for better system access, which is particularly important for search and domain name connection, resulting in good service qualities and good user experiences. It also increases reliability of connection to networks when a group of Service Codes instead of single one are in use by telecom terminals. Under such circumstances, the system moves to the next Service Code automatically when one Service Code is not connectable, and there is a group of codes can be chosen from. Because of automated connection and multi codes available, optimization and connectivity to networks is maximized.

On the other hand, the method and system of this invention to achieve domain name connection, to link with SMS information or WAP site, is fundamentally different in technological principles and functional mechanisms from the existing Internet connection by one key press, which is a launch commend function. The key press action launches browser software in telecom transmission terminals (computers or smart phones), is a function of activating an embedded software and follows with a sequence of execution within the terminal itself, in the contrary, key press action in the method and system of this invention to link information in SMS or to WAP sites initiates and executes the transmitting of Content Name or content, the remaining process and results are provided by receiving system in servers.

### BRIEF DESCRIPTION OF THE DRAWINGS

After reading the specific embodiments of the present invention in connection with the drawings by the readers, the respective aspects of the invention can be understood more clearly. Wherein:

FIG. 1 is block diagram of the invented system in the overall structure of wireless communication network

FIG. 2 is a block diagram of the preferred configuration of the hardware modules in the invented system.

FIG. 3 is a block diagram of the preferred configuration of the software functional modules in the invented system.

FIG. 4 is a flow diagram depicting a preferred process implemented by the presented system.

### DESCRIPTION OF THE PREFERRED EMBODIMENTS

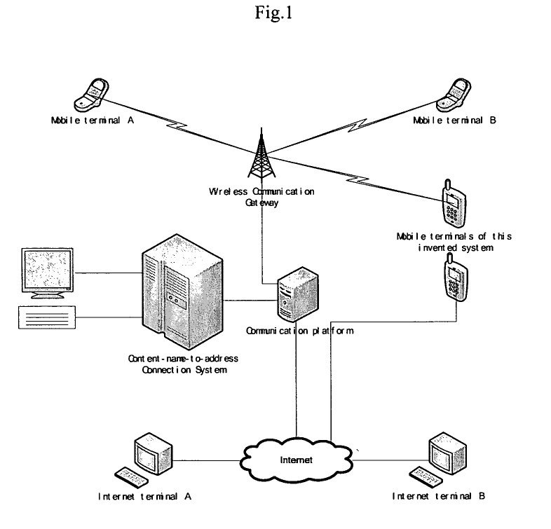

The presented invention relates to the field of network communication technologies and system configurations of hardware and software portions. FIG. 1 is a block diagram of the invented system in the overall structure of a wireless and instant communication network. The preferred architecture, comprising all hardware components and necessary software programs, can be divided into five portions: Wireless Terminals, a Wireless Communication Gateway, a Communication Platform, Internet Terminals, and Content-Name-to-Code connection System.

(1) Wireless Terminals are cell phones (or mobile devices) used by the end users, which must be registered with wireless networks, such as those of China Mobile or China Unicom, must be in either GSM mode or CDMA mode, and must support SMS technologies.

(2) A Wireless Communication Gateway is a server for sending/receiving/routing SMS set up by the Mobile Telecom Carriers. While its detailed system implementation is not restricted, it must provide a technical interface for the SMS Service Providers to connect to their systems.

(3) Internet Terminals are similar to many existing Internet terminal systems, must support network communication technologies and Internet communications protocols.

(4) A Communication Platform is a server for sending/receiving/routing SMS set up by the SMS Service Providers, which connects to the Wireless Communication Gateways of the Mobile Telecom Carriers either directly or through a secondary Wireless Communication Gateway set up by another SMS Service Provider that is one level up. A Communication Platform also connects to the Internet terminals at the same time. Instant communications occur between Internet Terminals, while wireless communications in SMS or MMS occur between Wireless Terminals or between Wireless Terminals and Internet Terminals.

(5) The Content-Name-to-Code connection System connects to a Communication Platform first, through which the connections between Wireless Terminals, between Wireless Terminals and Internet Terminals, and between Internet Terminals are established.

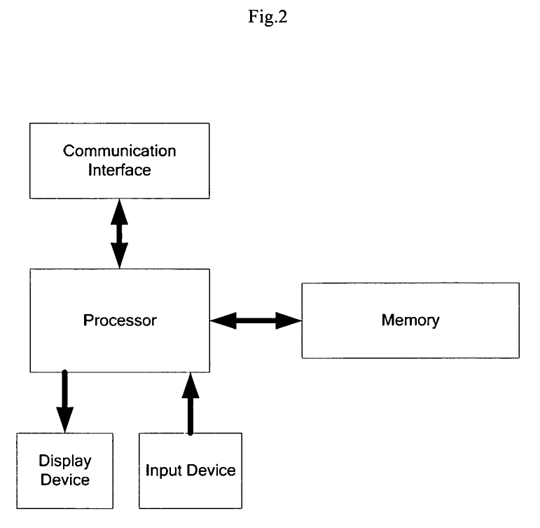

The invented system comprises a hardware portion and a software portion, and only the combination of both as a whole is capable of executing the functions of connecting words, phrases, or symbols of any languages or multimedia expressions, within the content of the transmitted data, to telecommunication codes. FIG. 2 is a block diagram of the preferred configuration of the hardware modules in the invented system. The hardware portion comprises a Processor, a Memory, a Display Device, an Input Device, and a Communication Interface, of which Processor is connected separately with Memory, Display Device, Input Device, and Communication Interface. These hardware portions can be these of prior arts and can be purchased in the open market. The telecom terminals of prior arts configured as above may meet the hardware requirements of the invented system, although they may not be the best fit.

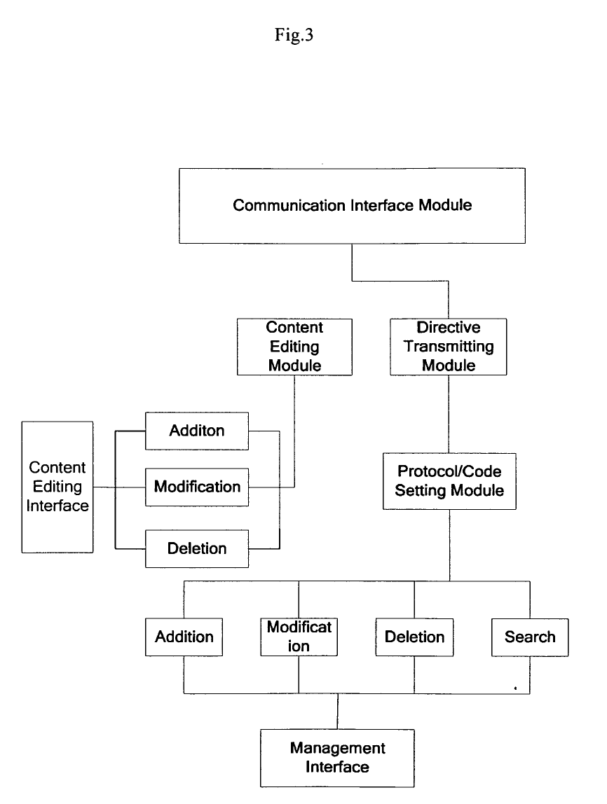

FIG. 3 is a block diagram of preferred software functional modules of the invented system. Such a software portion of telecom transmission terminal comprises Operating System, Protocol/Code Setting module, Content Editing Module, Directive Transmitting Module, Telecom Communication Interface Module, in which Protocol/Code Setting Module includes Management Interface and functions of Addition, Modification, Deletion and Search, and Content Editing Module includes Content Editing Interface and functions of Addition, Modifications and Deletion. Some software portions can be these of prior arts and can be purchased in the open market. The computers or telecom terminals of prior arts configured as above may meet the software requirements of the invented system, although they may not be the best fit, the functional configurations of the system for applications are based on the method of this invention. Protocol/Code Setting Module comprises sub modules for addition, deletion, modification, and search functions to configure and execute telecom transmission protocols or to activate Service Codes for transmission. Content Editing Module comprises sub modules for Addition, Modifications and Deletion functions. Directive Transmitting Module is the key functional part of software portion, which receives and processes transmitting content, detects and analyzes the requirements of transmission protocol or destination Service Codes, and finally directs the transmitted content to the Internet or Wireless Terminals associated with the connected transmission protocols or Telecom Service Codes via Communication Platform Module.

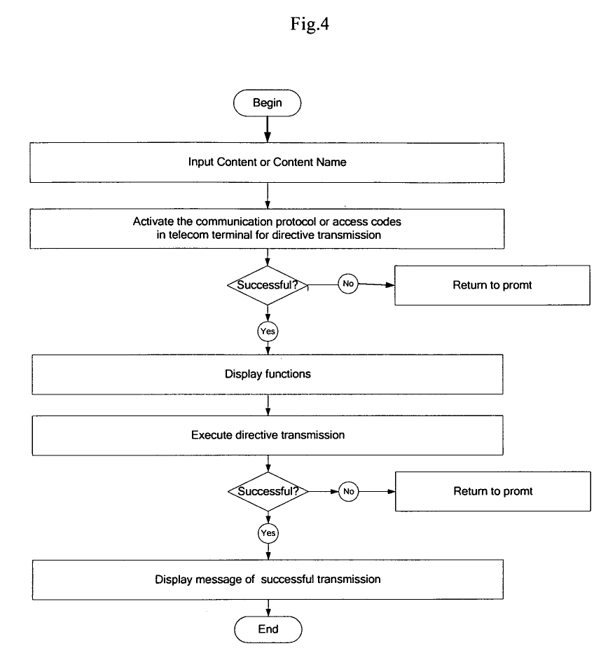

FIG. 4 is a work flow diagram for directive transmitting contents processed at telecom transmission terminals and for distributed content transmission connecting to networks, comprising:

a) Set up a content-name-to-address connection system, in which a group of Telecom Codes is selected, each of Telecom Codes is characterized with the first part as a directly dialed Head Code and the second part as a Sub Code that contains extra digits of Arabic numbers following the original Head Code. Each Sub Code within the selected group is non-ambiguous and unique, but can be the same set of numbers as the ones from other groups of Sub Codes or be connected to them. The selected group of Telecom Codes is configured in a database. Any digits of Telecom Codes in the selected group or any other groups are any characters permitted by telecom network systems.

b) In present content-name-to-address connection system, Collect Connecting Information Sources or URIs or IP Addresses and group them, then list in a Directory.

c) Define a unique format or form of any selected word(s), phrase(s), or symbol(s) from any languages, or of any multimedia expressions, or of any combination of the above, as a Content Name. Each of such unique Content Names can be located in any place within the transmitted data. All the defined Content Names are configured in a database.

d) Assign one specific or a specific group of Content Names to one specific or a specific group of Telecom Codes, and to one specific Connecting Content or URI or IP Address, between them the connection relations and the rules of directing are characterized as valid and executable, but are not necessarily on a one-to-one basis. Each of the connection relations and of the rules of directing is configured in the database.

e) Design a set of logic structures and computing programs to manage the Telecom Codes, Content Names, and connecting/directing functions, to receive and analyze the content transmitted, to detect the existence of any specific Content Name, and to redirect the transmitted content to the connected Telecom Codes; or to match particular URI or IP address with corresponding Content Name(s), and to redirect the connection that results in to display the content from a particular URI or IP address on Terminals.

f) The present system receives content or Content Name during transmitting telecom data, and connects words, phrases, or symbols of any languages to telecommunication codes, or to URI or IP Address

g) Design a telecom transmission terminal which processes and completes directive contents transmission, and connects to networks in distributed transmission mode.

h) Set relevant telecom transmission protocols or a group of telecom transmission codes associated with content-name-to-address connection system or other similar system in telecom transmission terminals, and each protocol or code responds in different sequence, different transmission contents are sent to different gateways from different telecom transmission terminals, as a result, telecom transmission terminals connect to network in distributed transmission mode.

In this method, Telecom Codes are Short Message Service (SMS) Short Codes provided by Mobile Telecom Carriers, or Sub Short Codes, which are extensions of SMS Short Codes along with the SMS Short Codes as the Head Codes and followed by any additional digits of any Arabic numbers up to a maximum of 15 digits; URI or IP Address is URI or IP Address of multimedia expression or stream media or are URIs or IP Addresses of multimedia expression or stream media; the contents of transmitted telecom data are SMS contents in wireless communications or instant message (IM) contents in instant communications; assignments of Content Names connecting to Telecom Codes are in three types: a specific Content Name connecting to a specific Telecom Code, a specific Content Name connecting to multiple Telecom Codes, and multiple Content Names connecting to a specific Telecom Code.

An example with a work flow depicting a preferred process implemented by the invented system demonstrates a preferred embodiment of a working process and working principles of the invented method.

Communication protocols or Service Codes need to be configured in Protocol/Code Setting module before attempting any functional effects of the system. As an example, SMS Service Code “915815” needs to be configured in a cell phone first. This can be done through four approaches.

1. Configured in the terminal's system;
2. Configured in the SIM card.
3. Configured in SIM card through STK;
4. Configured in embedded software system.

Next, confirm the validity of communication protocols or telecom Service Codes. When a cell phone user wants to find information regarding Shanghai Fengzhong Information Technology Co. Ltd. through accessing the company's SMS or WAP site, the user uses the Content Editing Module installed in cell phone to input “fengzhong” in Chinese, and launches the Directive Transmitting Module by pressing hardware key/button described in this invention, which detects and analyzes the requirements of transmission protocol or destination Service Codes configured in advance.

For instance, the SMS Service Code as “915815”, if it fails to detect, the Module will display the prompting message “cannot send”, if it detects successfully, the Module will display prompting message “search” or “log on”, user then confirm the action by pressing the key/button to activate Directive Transmitting Module and to transmit the content.

In addition, this confirming step can be omitted, the content can be transmitted directly after the Directive Transmitting Module detects protocols or Codes successfully.

If the content transmission fails, Directive Transmitting Module displays prompting message “transmission failed”, if content transmits successfully, the Module displays prompting message “please wait for result”.

Next, the corresponding system receives the query and processes it, then sends back the search result or domain name connection to the terminal for this user.

During the entire process, it does not require the cell phone user to know or to memorize any protocols or Telecom Service Codes.

This method and system for directive transmitting contents processed at telecom transmission terminals and for distributed content transmission connecting to networks, mainly relates to system structure of a network, and co-operative functions of an associated content-name-to-address connection system or similar systems, particularly relates to configuration and functions of telecom transmission terminals. This method and system improves and adds features and functions of telecom transmission terminal. As such, this method and system have solved the problems associated with long codes with many digits of numbers, which are very difficult to remember and cumbersome and inefficient to key in, in addition, it is an optimized structure as a distributed accessing system for telecom transmission terminals, in which network traffic balance and best utilization of network resources is achieved, when the number of users rises to high levels. This method and system also leads to the development of four new applications:
1. Linkage to SMS information or WAP site is initiated and executed when hardware key/button of telecom transmission terminal is pressed.

The method and system of this invention can initiate and execute the linkage of SMS information or WAP sites when hardware key/button of telecom transmission terminal is pressed, achieving functional effect of domain names. It no longer require terminal users to memorize and input any telecom Service Codes, only to input Content Name, such as “hospital”, in SMS, then to press hardware key/button on the terminal to send, users can receive the desired information from replied SMS or the linkage to an associated WAP site. As in the example mentioned above, this is very convenient and simple for mobile phone users to input “hospital” in SMS, and then press hardware key/button to send, users then receive relevant information in SMS linked to this Content Name or directed to the corresponding WAP site. WAP site linkage can lead to many contents, such as news summary, financial service (bank and securities), weather, travel, hotel, restaurant, insurance, health, fashion, entertainment, etc, the key point of this invented method and system is to provide a direct linkage from Content Name to the associated information supplied in SMS or WAP format and to provide the desired information for users.
2. Key word search is initiated and executed when hardware key/button of telecom transmission terminal is pressed.

The method and system of this invention can initiate and execute key word search in SMS when hardware key/button of telecom transmission terminal is pressed, effectively transforming SMS editing interface into a search key word input box. It no longer require terminal users to memorize and input any telecom Service Codes, only to input key word, such as “hospital”, in SMS, then to press hardware key/button on the terminal to send, users can receive the search result in SMS or WAP format. This search function can lead to many contents as search results, such as news summary, financial service (bank and securities), weather, travel, hotel, restaurant, insurance, health, fashion, entertainment, etc.
3. A general function is initiated and executed when hardware key/button of telecom transmission terminal is pressed.

The method and system of this invention can initiate and execute transmission of a unique format or form of a Content Name within the transmitting content when hardware key/button of telecom transmission terminal is pressed, such a Content Name can be any word(s), phrase(s), or symbol(s) of any language, or any combinations of the above, achieving a general functional effect of transmitting. During the process, it does not require terminal users to memorize and to input any telecom Service Codes.
4. Distributed connecting to networks by telecom transmission terminals.

Because it does not require users to memorize or to use a single telecom Service Code, each of different codes can be stored in different terminals, which serves as the foundation for distributed connecting to network by telecom transmission terminals. Transmitting contents from different terminals can be directed to different gateways by different Service Codes, resulting in a system structure of distributed connecting to networks. For example, users transmit content to a single Service Code, such as 93939, all transmitted contents are directed to a single gateway, which may cause communication traffic congestion, when there are multiple gateways in service, transmission becomes more efficient, and traffic flow are balanced for better system access, which is particularly important for search and domain name connection, resulting in good service qualities and good user experiences. It also increases reliability of connection to networks when a group of Service Codes instead of single one are in use by telecom terminals. Under such circumstances, the system moves to the next Service Code automatically when one Service Code is not connectable, and there is a group of codes can be chosen from. Because of automated connection and multi codes available, optimization and connectivity to networks is maximized.

On the other hand, the method and system of this invention to achieve domain name connection, to link with SMS information or WAP site, is fundamentally different in technological principles and functional mechanisms from the existing Internet connection by one key press, which is a launch commend function. The key press action launches browser software in telecom transmission terminals (computers or smart phones), is a function of activating an embedded software and follows with a sequence of execution within the terminal itself, in the contrary, key press action in the method and system of this invention to link information in SMS or to WAP sites initiates and executes the transmitting of Content Name or content, the remaining process and results are provided by receiving system in servers.

The method any system of this invention does not require users to memorize and to input any Telecom Service Codes at telecom transmission terminals, effectively initiating and executing functions of key word(s) search or SMS information response or WAP domain name connection or general connection with Content Name(s) by pressing hardware key/button, at the same time, achieving the distributed content transmission connecting to network for telecom terminals.

This description and drawings has helped to explain the technological principles and functional mechanisms of this invention, demonstrated by specific cases and applications. However, any modification and substitution of elements in the method and system of this invention does not constitute new inventions beyond the scope of this invention, therefore, the description and drawings serve as illustration purposes, not restrictive limitations of this invention.

1-9. (canceled)

10. A method for directive transmitting contents processed at telecom transmission terminals and for distributed content transmission connecting to networks, comprising:
setting up a content-name-to-address connection system, in which a group of Telecom Codes is selected, each of the Telecom Codes including a first part as a directly dialed Head Code and a second part as a Sub Code that contains extra digits of Arabic numbers following the original Head Code, wherein each Sub Code within the selected group is non-ambiguous and unique;
configuring the selected group of Telecom Codes in a database, wherein any digits of the Telecom Codes in the selected group or any other groups are any characters permitted by telecom network systems;
collecting, in the content-name-to-address connection system, Connecting Information Sources or URIs or IP Addresses and group them, then list the collection in a Directory;
defining a unique format or form of any selected word(s), phrase(s), or symbol(s) from any languages, or of any multimedia expressions, or of any combination of the above, as a Content Name, wherein each of such unique Content Names can be located in any place within a transmitted data, and the defined Content Names are configured in a database;
assigning one specific or a specific group of Content Names to one specific or a specific group of Telecom Codes, and to one specific Connecting Content or URI or IP Address, between them the connection relations and the rules of directing are characterized as valid and executable, but are not on a one-to-one basis, wherein each of the connection relations and of the rules of directing is configured in the database;
designing a set of logic structures and computing programs to manage the Telecom Codes, Content Names, and connecting/directing functions, to receive and analyze the content transmitted, to detect the existence of any specific Content Name, and to redirect the transmitted content to the connected Telecom Codes or to match particular URI or IP address with corresponding Content Name(s), and to redirect the connection that results in to display the content from a particular URI or IP address on Terminals;
receiving content or Content Name during transmitting telecom data, and connects words, phrases, or symbols of any languages to telecommunication codes, or to URI or IP Address;
designing a telecom transmission terminal which processes and completes directive contents transmission, and connects to networks in distributed transmission mode; and
setting relevant telecom transmission protocols or a group of telecom transmission codes associated with the content-name-to-address connection system or other system in telecom transmission terminals, and each protocol or code responds in different sequence, different transmission contents are sent to different gateways from different telecom transmission terminals, wherein the telecom transmission terminals connect to network in distributed transmission mode.

11. The method in claim 10, wherein Telecom Codes are Short Message Service (SMS) Short Codes provided by Mobile Telecom Carriers, or Sub Short Codes, which are extensions of SMS Short Codes along with the SMS Short Codes as the Head Codes and followed by any additional digits of any Arabic numbers up to a maximum of 15 digits.

12. The method in claim 10, wherein URI or IP Address is URI or IP Address of multimedia expression or stream media or are URIs or IP Addresses of multimedia expression or stream media.

13. The method in claim 10, wherein the contents of transmitted telecom data are SMS contents in wireless communications or instant message (IM) contents in instant communications.

14. The method in claim 10, wherein assignments of Content Names connecting to Telecom Codes are in three types: a specific Content Name connecting to a specific Telecom Code, a specific Content Name connecting to multiple Telecom Codes, and multiple Content Names connecting to a specific Telecom Code.

15. The method in claim 10, wherein the telecom content transmission is initiated to process within the telecom transmission terminal when a hardware key/button is pressed.

16. The method in claim 15, wherein the telecom content transmission initiated for processing within the telecom transmission terminal is the action of key word(s) searching or connecting WAP/SMS site(s) by the Content Name when a hardware key/button is pressed.

17. The method in claim 10, wherein the hardware part of telecom transmission terminal includes a Processor, a Memory, a Display Device, an Input Device, and a Communication Interface, which are computing hardware components or hardware components of mobile terminals; and software portion of telecom transmission terminal comprises computing operation systems with compatible software functional modules or operating systems for mobile terminals of prior arts with compatible software function modules.
